(19) United States
(12) Patent Application Publication
(10) Pub. No.: US 2015/0010675 A1
(43) Pub. Date: Jan. 8, 2015

(54) PURPLE CORN NECTAR CONTAINING ANTHOCYANINS METHODS FOR MAKING AND APPLICATIONS THEREOF

(71) Applicants: Regina Celia Bertoldo de Barros, Minneapolis, MN (US); Michele Ann Majeski, Maplewood, MN (US)

(72) Inventors: Regina Celia Bertoldo de Barros, Minneapolis, MN (US); Michele Ann Majeski, Maplewood, MN (US)

(73) Assignee: SUNTAVA, INC., AFTON, MN (US)

(21) Appl. No.: 14/321,702

(22) Filed: Jul. 1, 2014

Related U.S. Application Data
(60) Provisional application No. 61/843,132, filed on Jul. 5, 2013.

(51) Int. Cl. A23L 1/30; A23G 3/48; A23L 1/105; C12G 1/00; A23L 2/52; A23L 1/10; C12C 5/02

(52) U.S. Cl. CPC A23L 1/3002; A23L 1/1041; A23G 3/48; C12C 5/02; C12G 1/00; A23L 2/52; A23L 1/105; A23V 2002/00
USPC 426/28; 426/542

(57) ABSTRACT

The present invention relates among other things to an enzymatically produced purple corn nectar having a composition comprising saccharides and anthocyanins. The anthocyanin composition is present in concentrations of at least 40 mg/100 g of nectar and is a direct result of the process of making the corn nectar from the purple corn kernels and does not constitute an exogenous addition to the purple corn nectar. The current invention also relates to consumable compositions made from the said purple corn nectar.

### CROSS REFERENCE TO RELATED APPLICATIONS

This application claims benefit, under 35 U.S.C §119(e), to U.S. Patent Provisional Application No. 61/843,132 filed on Jul. 5, 2013 the disclosure of which is herein incorporated by reference in its entirety.

### FIELD

Methods for making purple corn nectar that contains native anthocyanins originating from the source purple corn kernels and methods for using the same are provided.

### BACKGROUND OF THE INVENTION

There is ample need and demand for foods containing antioxidants such as anthocyanins. Oftentimes, these antioxidants are added to products such as juices, candy and other consumables. The public is however increasingly becoming suspicious of compounds that are not native to the source material of the consumables and are instead added during the process. Furthermore current regulations are requiring manufacturers to disclose more about the composition of the products sold to the public and to label their products in such a way as to reflect any added materials. To respond to the consumer's demand, many manufacturers are starting to emphasize the preservation of certain compounds during the process of making a given consumable rather than adding them later. For instance, certain proteins and vitamins that are usually eliminated during the manufacturing process are now preserved to give extra value to the consumable. However, with the attempt to preserve these compounds come new manufacturing challenges. Oftentimes, some of these challenges relate to the fact that some of the compounds that one is trying to preserve degrade during the processing of the desired product. Furthermore, other non-desirable solids tend to get extracted during the process.

Corn nectars or syrups and the processes to make them are known in the art. U.S. Pat. No. 2,822,303 describes a method for making corn starting from a starch. There is a need however for a corn nectar that contains native anthocyanins (originating from the kernels used in the process itself) and manufacturing methods for making it.

The current invention aims, among other things, to provide such methods for the manufacture of a purple corn nectar containing anthocyanins, native to the very kernels used in the manufacturing of the nectar, in amounts that exceed those in known corn nectar manufacturing methods while minimizing the extraction of other solids that can interfere with the nectar making process.

### SUMMARY OF THE INVENTION

Generally, in some of its embodiments, the invention aims to provide methods that result in a purple corn nectar composition having an antioxidant profile high in native anthocyanins resulting directly from the kernels used in process of making the nectar. In other embodiment, the invention provides brewing compositions containing a certain amount of the said purple corn nectar as well as confectioneries containing the purple corn nectar. More particularly, the invention relates to a corn nectar having high anthocyanin content as well as consumables made from the invention and its dried products thereof.

Objects and advantages of the invention are set forth in part in the ensuing description, or may be obvious from the description, or may be learned through practicing the invention. Suitable methods and compositions are described herein without limitations on the scope of the invention.

### DETAILED DESCRIPTION OF THE INVENTION

In this application the words nectar and syrup are equivalent and maybe used interchangeably. The word “grits” is used to mean corn kernels ground to a particle size which could be as fine as a flour or meal or as coarse as several hundred microns. For simplicity when the grits are larger than 600 microns they will be called grits and when they are smaller than 600 microns they will be called flour or meal. The words candy bar, nutritional bar or health bar are intended to mean the same product.

In one of its embodiments, the invention describes a first method for obtaining a purple corn nectar having total solids in excess of sixty percent by weight and having an anthocyanin content in excess of 80 milligrams per one hundred grams of nectar from purple corn grits. The grits were chosen such that the majority of them had a size larger than 1200 microns. For instance in one of the examples the purple corn grits were chosen such that more than 50% of the grits had a size larger than 1200 microns, larger than 1200 microns but smaller than 3350 microns, preferably larger than 1200 microns but smaller than 1680 microns, more particularly, 65% to 70% of them were larger than 1500 microns but less than 3500 microns. A first acid hydrolysis was carried out on the grits by steeping them in water that has been acidified by the addition of enough sulphuric acid to reach a pH below 7 and more particularly below 6 but preferably below 5. As described in example 1, the acid hydrolyzed grits were then subjected to the action of the two saccharifying enzymes San Extra and Saczyme. A filtrate was obtained that had about 1.89% solids (table 8 in the examples section). When concentrated to about 70% solids as shown in table 9 (Nectar 1), the nectar obtained showed an anthocyanin content of about 86 milligrams per 100 grams of nectar.

In another embodiment of the invention, purple corn grits were chosen such that more than 50% of the grits had a size larger than 1200 microns, larger than 1200 microns but smaller than 3350 microns, preferably larger than 1200 microns but smaller than 1680 microns, more particularly, 65% to 70% of them were larger than 1500 microns but less than 3500 microns. A first acid hydrolysis was carried out on the grits by steeping them in water that has been acidified by the addition of enough sulphuric acid to reach a pH below 7 and more particularly below 6 but preferably below 5. As described in example 2 and tables 8 and 9, the acid hydrolyzed grits were then subjected to the action of the two saccharifying enzymes Alpha-Amylase and Saczyme. After the action of these two enzymes, the hydrolyzed product maybe further subjected to isomerizing enzymes if for instance, high fructose nectars are desired. In example 2, a filtrate was obtained that had about 1.88% solids (table 8 in the examples section). When concentrated to about 65% solids, as shown in table 9 (nectar 2), the nectar obtained showed an anthocyanin content of about of 84 milligrams per 100 grams of nectar.

Comparatively, when corn meals/flours, having particles sizes much less than 600 microns as shown in table 5 and described in comparative examples 3 and 4, are used to make the nectars, the purple corn nectars obtained, (nectars 3 and 4 in table 9), while slightly higher in total carbohydrates than the ones obtained from the larger size grits they show significantly lower concentrations of anthocyanins only 43 to 74 mg per 100 g of nectar as compared to 84 to 86 mg per 100 g of nectars from the grits (table 9). A close inspection of table 8 demonstrates that the smaller size of the corn meal particles enables extraction of far more solids which is shown from these results to be a detrimental factor to the extraction of higher amounts of total anthocyanins. While not intending to be bound by any theories, the investigators recognized that a certain size of grits when hydrolyzed in the presence of acids and treated with saccharifying enzymes, of the type described in the invention, produce nectars higher in total anthocyanins than purple corn meals (flours) with particle sizes much below 600 microns. It can be appreciated from table 10 that grits having a size predominantly between 1200 microns and 33350 microns show an average anthocyanin contents at least 60% higher than their counterparts with sizes much below 600 microns. On skilled in the art could for instance use the larger size grits to obtain nectars that are much higher in anthocyanins but only slightly lower in total carbohydrates.

The purple corn nectar of the invention is useful in many applications and in particular consumable compositions. The purple corn nectar of the current invention finds uses as a sweetener, thickener, binder, natural colorant and a source of antioxidants. These consumable compositions may contain various amounts of the purple corn nectar of the invention as a liquid or a dried form. Ranges vary from a few milligrams to several hundred grams in the total consumable composition depending on the application.

For instance in one of the embodiments of the invention, the purple corn nectar is used as a substrate for alcoholic fermentation for a beer. Example 7 describes a process of making a purple beer using the purple corn nectar of the invention as a suitable substrate for alcoholic fermentation. In this example for instance hops were replaced by purple corn kernels.

The purple corn nectar of the invention not only provides the source of sugar for the yeast but also an antioxidant source both for nutritional value and protection of the beer against the oxidative effects of oxygen. Furthermore, the purple corn nectar of the invention serves as a colorant for the beverage. In some other embodiment of the invention the purple corn nectar of the invention is used as an additive to the fermentation of other fruits or grains. One skilled in the art can easily determine from the description of this invention suitable proportions of the nectar for each intended application.

In other embodiments of the invention such as drinks, the purple corn nectar of the invention is used as not only as a suitable sweetener but also as a colorant and antioxidant. The juices of this embodiment can be natural juices such as orange and other fruit juices as well as artificial juices and lemonades as described in example 9. One skilled in the art may choose to dry the purple corn nectar of the invention and use the dried resulting product in any of the embodiments discussed above. One may also supplement the resulting dried product with other nutritional or non-nutritional compounds.

In another embodiment of this invention and in particular in the nutritional (snack bar) bar, health snacks and candy manufacturing industry, a binder is often required to hold the different components together thus acting like a glue. The corn nectar of the invention lends itself to such application. Furthermore, the purple corn nectar of the invention is not only capable of contributing by its mechanical utility but also by its added nutritional value of delivering sufficient amounts of antioxidant to the candy bar or health and nutritional bar.

In some aspect of the current invention, the purple corn nectar of the invention is used to provide the natural safe color desired for the application. Example 6 describes one of the embodiments of the invention whereby a composition for making a snack bar comprises as one of its elements the purple corn nectar of the invention. Alternatively, example 5 describes an embodiment of the invention teaching the application of the invention to the manufacturing of a hard candy consumable.

The following examples are presented to further illustrate and explain the present invention and should not be taken as limiting the scope of the invention in any regard.

### EXAMPLES

TABLE 1
Purple corn grits and purple corn meal (flour)
used in the invention supplied by Suntava, Inc.

| Starting Material | Product code | Lot # |
|---|---|---|
| Purple corn grits | 220102 | 3273NM06 |
| Purple corn meal (flour) | 220106 | 113099 |

TABLE 2
Composition of the purple corn grits

| | % of composition |
|---|---|
| Fats | 5 |
| Protein | 9 |
| Carbohydrates | 70 to 85 |
| Moisture | <15 |

TABLE 3
Size distribution of the purple corn grits

| US Standard mesh | Size | |
|---|---|---|
| size | (microns) | % Retained |
| #6 | 3350 | 12 to 16 |
| #12 | 1700 | 65 to 69 |
| #16 | 1180 | 9 to 13 |
| >#16 | <1180 | 2 to 14 |

TABLE 4
Composition of the purple corn meal (purple corn flour)

| | % of composition |
|---|---|
| Fats | 5 |
| Protein | 9 |
| Carbohydrates | 70 to 85 |
| Moisture | <15 |

TABLE 5
Size distribution of the purple corn meal/flour

| US Standard mesh | Size | |
|---|---|---|
| size | (microns) | % Retained |
| #30 | 600 | 0 |
| #40 | 425 | ≦20 |
| #60 | 251 | ≦75 |
| #100 | 150 | ≦15 |
| >#100 | <150 | trace |

TABLE 6
Enzymes used in the process

| | Name used in | |
|---|---|---|
| Enzyme | Description | Manufacturer |
| C&B alpha-amylase (powder) | Alpha-Amylase | Crosby & Baker, Ltd |
| SAN Extra L*K*N - alpha- | San Extra | Gusmer Enterprises |
| amylase/glucoamylase (liquid) | | |
| Saczyme*K*N - glucoamylase | Saczyme | Gusmer Enterprises |
| (liquid) | | |

TABLE 7
Identification of nectars and treatments

Syrup 1 = Grits + San Extra + Saczyme
Syrup 2 = Grits + Alpha-Amylase + Saczyme
Syrup 3 = Corn flour + San Extra + Saczyme
Syrup 4 = Corn flour + Alpha-Amylase + Saczyme

TABLE 8
% Solids of the initial filtrates of the grits
and corn meal/flour before concentration

| | Average Solids of |
|---|---|
| Samples | initial extract |
| Grits + San Extra + Saczyme | 1.89% |
| Grits + Alpha-Amylase + Saczyme | 1.88% |
| Corn meal + San Extra + Saczyme | 6.13% |
| Corn meal + Alpha-Amylase + Saczyme | 3.90% |

TABLE 9
% Solids, carbohydrates and anthocyanin of the final
nectars after concentration of the initial filtrate

| | % solids | Total carbohydrates | Total Anthocyanin in |
|---|---|---|---|
| | final syrup | (g/100 g) | final syrup mg/100 g) |
| Syrup 1 | 70.0 | 50.24 | 86 |
| Syrup 2 | 65.0 | 51.14 | 84 |
| Syrup 3 | 76.0 | 61.82 | 43 |
| Syrup 4 | 85.0 | 61.86 | 74 |

TABLE 10
Total amount of anthocyanins of the nectars on dry basis.

| Sample | mg/100 g (Dry Basis) |
|---|---|
| Nectar 1 | 134.23 |
| Nectar 2 | 127.93 |
| Nectar 3 | 61.73 |
| Nectar 4 | 98.76 |

### Method for Determination of the Anthocyanins Content of the Nectars

A modified version of the method described in “Characterization and measurement of anthocyanins by UV-Visible spectroscopy” by M. Monica Giusti and Ronald Wrolstad, Current Protocols in Food Analytical Chemistry (2001) F1.2.1-F1.2.13, Copyright © 2001, John Wiley & Sons, Inc. was used to determine the content of anthocyanins in the different nectars, using the THERMO SCIENTIFIC™ Evolution Spectrop[hotometer.

### Suntava Anthocyanin Evaluation

E551 Buffer Preparation (wear personal protective equipment):
Dissolve 10 ml of concentrated hydrochloric acid (HCl) in about 250 mL of distilled water. Bring volume to 500 mL with extra deionized (dI) water.
Add 500 mL of 95% ethyl alcohol (190 proof).
Mix well before use. Buffer pH should be around 1-1.2

### Procedure:

The ratio of sample to E551 buffer is 10:90 (2 g sample+18 g E551 buffer).
Gravity-filter through funnel using glass fiber filter paper (VWR 28333-127).
Prepare dilutions for measurements immediately after filtration to avoid/minimize evaporation. Always use a control sample to keep procedure in check.

### Measurements/dilutions:

Prepare dilutions (wt/wt) using E551 buffer and run the appropriate wavelength scan to collect peak wavelength (typically 400-800 nm).
   Calculations for monomeric anthocyanin:

Monomeric anthocyanin(mg/L)=(A*MW*DF*1000)/(ε*1)

### Where:

A=absorbance (absorbance reading at peak wavelength)
MW=molecular weight (449.2 for cyanidin-3-glucoside)
DF=dilution factor
ε=molar absorptivity (26900)

Method for Determination of % Solids in the Samples Before and after Concentration

Weigh and record the weight of an aluminum pan, add 5 mL of material, record weight, place to dry at 65° C./18-24 hrs then weigh again. Run sample in duplicates. Calculate average % solids based on the moisture weight loss.

The grits and corn meal extractions were all run in duplicates and values for all measurements were averaged and reported as average values.

### Example 1

### Grits with San Extra+Saczyme

### Ingredients

### Water

Concentrated sulphuric acid (Sold by Sigma Aldrich)
Suntava purple corn grits product code 220102, lot #3273NM06 (supplied by Suntava, Inc.)

### San Extra

### Saczyme

### Method:

1920 g of water contained in a stainless steel container is brought to a temperature between 55 and 60° C. To this, 330 g of corn grits are added. Next approximately 0.035 g of concentrated sulphuric acid is added to achieve a starting pH of 5.35. The container with its content is then loosely covered with a lid and placed at 60° C. in an oven overnight (about 20 hrs). The next day, the container with its content is removed from the 60° C. and 5 ml of San Extra is added to the content. The content is then stirred and allowed to cool to 35° C. At this point the content is filtered through a colander lined with a fine mesh cheese cloth. 5 ml of Saczyme is then added to the now filtered content and mixed well. The filtered content is then brought to 60° C. on an electric burner top to activate the enzymes. It is then placed at 60° C. in an oven for 30 min. After this, the whole filtered content is brought to a boil and held there for 1 minute to stop the enzymatic activity. It is then left to simmer at medium-low for 15 minutes. The filtered content is then further filtered through a bag filter (nominal size of one micron) using a vacuum filtration apparatus known in the art. At this point the final pH, the concentration of anthocyanins as well as the weight of the filtrate recovered are determined. The recovered filtrate is then placed to dry overnight at 60° C. in an air air oven.

### Example 2

### Grits with Alpha-Amylase and Saczyme

### Ingredients:

### Water

Concentrated sulphuric acid (Sold by Sigma Aldrich)
Suntava purple corn grits product code 220102, lot #3273NM06 (supplied by Suntava, Inc.)

### Alpha-Amylase

### Saczyme

### Method:

1920 g of water contained in a stainless steel container is brought to a temperature between 55 and 60° C. To this, 330 g of corn grits are added. Next approximately 0.035 g of concentrated sulphuric acid is added to achieve a starting pH of 5.35. The container with its content is then loosely covered with a lid and placed at 60° C. in an oven overnight (about 20 hrs). The next day the container with its content is removed from the 60° C. and 5 g of Alpha-Amylase is added to the content. The content is then stirred and allowed to cool to 35° C. At this point the content is filtered through a colander lined with a fine mesh or cheese cloth. 5 ml of Saczyme is then added to the now filtered content and mixed well. The filtered content is then brought to 60° C. on an electric burner top to activate the enzymes. It is then placed at 60° C. in an oven for 30 min. After this, the whole filtered content is brought to a boil and held there for 1 minute to stop the enzymatic activity. It is then left to simmer at medium-low for 15 minutes. The filtered content is then further filtered through a bag filter (nominal size of one micron) using a vacuum filtration apparatus known in the art. At this point, the pH, the % solids and the % filtrate recovered are determined. The recovered filtrate is then placed to dry overnight at 60° C. in an air oven.

### Comparative Example 3

### Purple Corn Meal with San Extra and Saczyme

### Ingredients:

### Water

Concentrated sulphuric acid (Sold by Sigma Aldrich)
Suntava purple corn meal product code 220106, lot #113099 (supplied by Suntava, Inc.)

### San Extra

### Saczyme

### Method:

1920 g of water contained in a stainless steel container is brought to a temperature between 55 and 60° C. To this, 330 g of corn meal/flour are added. Next approximately 0.035 g of concentrated sulphuric acid is added to achieve a starting pH of 5.75. The container with its content is then loosely covered with a lid and placed at 60° C. in an oven overnight (about 20 hrs). The next day the container with its content is removed from the 60° C. oven and 5 ml of San Extra is added to the content. The content is then stirred and allowed to cool to 35° C. At this point the content is filtered through a colander lined with a fine mesh or cheese cloth. 5 ml of Saczyme is then added to the now filtered content and mixed well. The filtered content is then brought to 60° C. on an electric burner top to activate the enzymes. It is then placed at 60° C. in an oven for 30 min. After this, the whole filtered content is brought to a boil and held there for 1 minute to stop the enzymatic activity. It is then left to simmer at medium-low for 15 minutes. The filtered content is then further filtered through a bag filter (nominal size of one micron) using a vacuum filtration apparatus known in the art. At this point, the pH, the % solids and the % filtrate recovered are determined. The recovered filtrate is then placed to dry overnight at 60° C. in an air oven.

### Comparative Example 4

### Purple Corn Meal with Alpha-Amylase and Saczyme

### Ingredients:

### Water

Concentrated sulphuric acid (Sold by Sigma Aldrich)
Suntava purple corn meal product code 220106, lot #113099 (supplied by Suntava, Inc.)

### Alpha-Amylase

### Saczyme

### Method:

1920 g of water contained in a stainless steel container is brought to a temperature between 55 and 60° C. To this, 330 g of corn meal/flour are added. Next approximately 0.035 g of concentrated sulphuric acid is added to achieve a starting pH of 5.75. The container with its content is then loosely covered with a lid and placed at 60° C. in an oven overnight (about 20 hrs). The next day, the container with its content is removed from 60° C. and 5 g of Alpha-Amylase is added to the content. The content is then stirred and allowed to cool to 35° C. At this point, the content is filtered through a colander lined with a fine mesh or cheese cloth. 5 ml of Saczyme is then added to the now filtered content and mixed well. The filtered content is then brought to 60° C. on an electric burner top to activate the enzymes. It is then placed at 60° C. in an oven for 30 min. After this, the whole filtered content is brought to a boil and held there for 1 minute to stop the enzymatic activity. It is then left to simmer at medium-low for 15 minutes. The filtered content is then further filtered through a bag filter (nominal size of one micron) using a vacuum filtration apparatus known in the art. At this point, the pH, the % solids and the % filtrate recovered are determined. The recovered filtrate is then placed to dry overnight at 60° C. in an air oven.

### Example 5

### Hard Candy Formulation Using Purple Corn Nectar from the Invention

### Ingredients:

White sugar—197 g

### Purple Corn Nectar—100 g

### Water—56 g

Combine all ingredients. Stir and heat on medium-high heat using portable burner.
Bring to boil. Do not stir. Continue boiling until when a small amount dropped into cold water forms hard drop. NOTE: If boiled too long, candy will burn and become discolored (brownish).
When finished boiling, remove from heat.
Pour candy into small ice cube trays brushed with oil. Allow to completely cool before removing.

### Example 6

### Snack Bar Using Purple Corn Nectar from the Invention

### Ingredients:

1 cup pitted dates
¼ cup of Suntava purple corn nectar
¼ cup of creamy nut butter
1 cup roasted nuts (almonds or peanuts)
1½ cup of rolled oats
In a food processor, add the dates and blend them for a minute to make a dough.
Combine all dry ingredients (oats, nuts and dates) in a bowl and set it aside.
Add Suntava Purple Corn nectar and the nut butter to a small pan. Mix well and warm up the mixture to form a uniform creamy mixture. Pour the mixture over the dry ingredients and mix well.
Transfer the whole mixture onto a flat pan lined with parchment paper. Press down until a uniform surface is formed. Cover and place in the refrigerator to harden. Cut bars into desired pieces before serving.

### Example 7

### Beer Made with Purple Corn Nectar from the Invention

### Ingredients:

### Suntava Purple Corn

### Suntava Purple Corn Nectar

### Beer Yeast:

Fermentis Safale Us-05 Dry Ale Yeast obtained from Fermentis

### Dosage: 11.5 g in 20-30 L

Optimal yeast Temperature range: 15-24 C (59-75 F)

### Beer Procedure:

Heat 1.36 liter water until warm in microwave (2 minutes per 1 L water).
In 2 liter plastic container, add warm water, approximately 1 cup Suntava Purple Corn nectar, 1.5 g yeast and 1 cup Suntava Purple Corn (185 g).
Cover with lid. Place in warm, dark place (not below room temperature) for at least 24 hours.
After 24 hours, strain through colander to remove kernels.
Pour into plastic bottles approximately one half to 3 quarters full (total four 12 oz bottles). Loosely cap and place again in warm, dark place.
Allow mixture to ferment until gas evolution has stopped.

### Example 8

### Wine Made with Purple Corn Nectar from the Invention

### Ingredients:

### Suntava Purple Corn

### Suntava Purple Corn Nectar

Wine Yeast Lalvin RC-1118 Saccharomyces cerevisiae—champagne obtained from Lallemand.
Dosage: 5 g makes 1-6 gallons

### Wine Procedure:

Place 1 cup Suntava Purple Corn in container. Pour 1 liter boiling water over kernels.
Cover with paper towels, cheesecloth or dish towel and let stand for 24 hours at room temperature.
After 24 hours, strain through colander to remove kernels. Add approximately 2¼ cup Purple Corn Nectar and 1 g of yeast. Pour into 2 liter plastic bottle and mix well. Cap loosely. Leave at room temperature.
Allow it to ferment until desired percent alcohol and flavor profile is reached.

### Example 9

### Nonalcoholic Drink Made from Purple Corn Nectar of the Invention

### Ingredients:

1 cup fresh lemon juice
3 to 4 cups cold water (depending on desired strength)
½-1 cup Purple Corn Nectar (or to taste)

### Method:

Combine fresh lemon juice, Purple Corn nectar and water. Mix well until nectar has completely dissolved. Add more Purple Corn nectar depending on desired sweetness. Refrigerate.

What is claimed is:

1. A process for making purple corn nectar containing native anthocyanins, said process comprising the acts of:
a. grinding purple corn kernels to form purple corn grits;
b. adding sufficient water to cover the above purple corn grits and stirring to mix the grits and water;
c. reducing the pH of the water and grits suspension with an acid to a value between 4 and 5;
d. holding the acidified water and grits suspension at 60° C. for about 20 hours;
e. removing the suspension from the 60° C. temperature;
f. adding a first saccharification enzyme;
g. cooling the acidified grits and water after the first saccharification enzyme to 35° C.;
h. filtering the mixture from step (g) in a colander lined with cheese cloth or a fine mesh fabric;
i. adding a second saccharification enzyme and stirring well;
j. bringing the mixture to 60° C. and holding it at this temperature for 30 minutes;
k. bringing the mixture to a boil and holding for 1 minute
l. simmering the mixture for 15 minutes;
m. fine filtering the mixture
n. concentrating the said mixture to form a nectar by evaporation.

2. The process of claim 1 wherein the grits have a particle size less than 600 microns.

3. The process of claim 1 wherein the grits have a size larger than 600 microns.

4. The process of claim 1 further comprising the act of evaporating a substantial amount of the water to obtain a powder.

5. The process of claim 1 further comprising the act of adding an isomerizing enzyme.

6. The purple corn nectar of claim 1

7. The dried purple corn nectar of claim 4.

8. The purple corn nectar of claim 6 wherein the content of the anthocyanins is at least 40 milligrams per 100 g of nectar.

9. The dried purple corn nectar of claim 7 wherein the content of the anthocyanins is at least 40 milligrams per 100 g of nectar per dry basis.

10. A consumable composition comprising any amount of the purple corn nectar of claim 6.

11. A consumable composition comprising any amount of the dried purple corn nectar of claim 7.

12. The consumable composition according to claim 10 wherein the consumable composition is a brewing composition.

13. The consumable composition according to claim 11 wherein the consumable composition is a brewing composition.

14. The consumable composition according to claim 10 wherein the consumable composition is a candy bar.

15. The consumable composition according to claim 11 wherein the consumable composition is a candy bar.

16. The consumable composition according to claim 10 wherein the consumable composition is a nonalcoholic drink.

17. The consumable composition according to claim 11 wherein the consumable composition is a nonalcoholic drink.
